(19) United States
(12) Patent Application Publication
(10) Pub. No.: US 2010/0146444 A1
(43) Pub. Date: Jun. 10, 2010

(54) Motion Adaptive User Interface Service

(75) Inventors: Zheng Wang, Redmond, WA (US); Steven P. Dodge, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/329,066

(22) Filed: Dec. 5, 2008

(51) Int. Cl. G06F 3/048; G06F 3/00

(52) U.S. Cl. 715/815; 715/866

(57) ABSTRACT

Motion adaptive user interface service is described. In embodiment(s), a user interface can be displayed on an integrated display of a device when an application is executed on the device. Context data associated with movement of the device can be received and used to determine an enhancement of the user interface for ease of usability. The enhancement can then be initiated to modify the user interface while the device is in motion.

### BACKGROUND

Computing devices are increasingly more common and mobile, such as personal media devices, laptop computers, tablet PCs, ultra-mobile PCs, as well as other mobile data, messaging, and/or communication devices. Computing devices, however, can be difficult to use when a user is moving and trying to manipulate user interface controls displayed on a device, such as when a computer device is being jostled in a vehicle or when jogging with a portable device. User interfaces of applications executing on portable and/or computing devices are typically optimized for use when both a user and the device are stationary.

### SUMMARY

This summary is provided to introduce simplified concepts of a motion adaptive user interface service. The simplified concepts are further described below in the Detailed Description. This summary is not intended to identify essential features of the claimed subject matter, nor is it intended for use in determining the scope of the claimed subject matter.

In embodiment(s) of a motion adaptive user interface service, a user interface can be displayed on an integrated display of a device when an application is executed on the device. Context data associated with movement of the device can be received and used to determine an enhancement of the user interface for ease of usability. The enhancement can then be initiated to modify the user interface while the device is in motion.

In other embodiment(s), user-selectable controls of the application that are displayed on the user interface can be rearranged, resized, removed, and/or reshaped for ease of usability. For instance, a user-selectable control that is displayed on the user interface, and that is selectable by touching the control, can be increased in size when a user is running so that the user-selectable control is easier to see and select by the user. In various embodiments, a user-selectable control can be increased in size for ease of usability, and/or a user-selectable control can be removed from the user interface.

In other embodiment(s), the context data that is associated with movement of a device can include acceleration data and/or positioning data. In some embodiments, the context data can be received from sensors integrated with the device. For instance, an accelerometer can be integrated with the device to provide acceleration data. Similarly, a GPS unit or module can be integrated with the device to provide positioning data.

### BRIEF DESCRIPTION OF THE DRAWINGS

Embodiments of a motion adaptive user interface service are described with reference to the following drawings. The same numbers are used throughout the drawings to reference like features and components:

FIG. 1 illustrates an example system in which embodiments of a motion adaptive user interface service can be implemented.

FIG. 2 illustrates an example implementation of a motion adaptive user interface service on a portable device.

FIG. 3 illustrates example method(s) for motion adaptive user interface service in accordance with one or more embodiments.

FIG. 4 illustrates various components of an example device that can implement embodiments of a motion adaptive user interface service.

### DETAILED DESCRIPTION

Embodiments of a motion adaptive user interface service provide that a portable and/or computing device can receive context data that indicates when the device is in motion, or being moved. A motion adaptive user interface service can determine movement of the device based at least in part on the context data. The motion adaptive user interface service can then initiate an enhancement of a user interface displayed on the device based on the movement of the device. The enhancement can provide that the user-interface is easier to see and/or operate as the device is being moved, or moving. For example, user-selectable controls on a user interface may be enlarged when it is determined that a user of the device is jogging to make it easier for the user to see and select the controls.

While features and concepts of the described systems and methods for a motion adaptive user interface service can be implemented in any number of different environments, systems, and/or various configurations, embodiments of a motion adaptive user interface service are described in the context of the following example systems and environments.

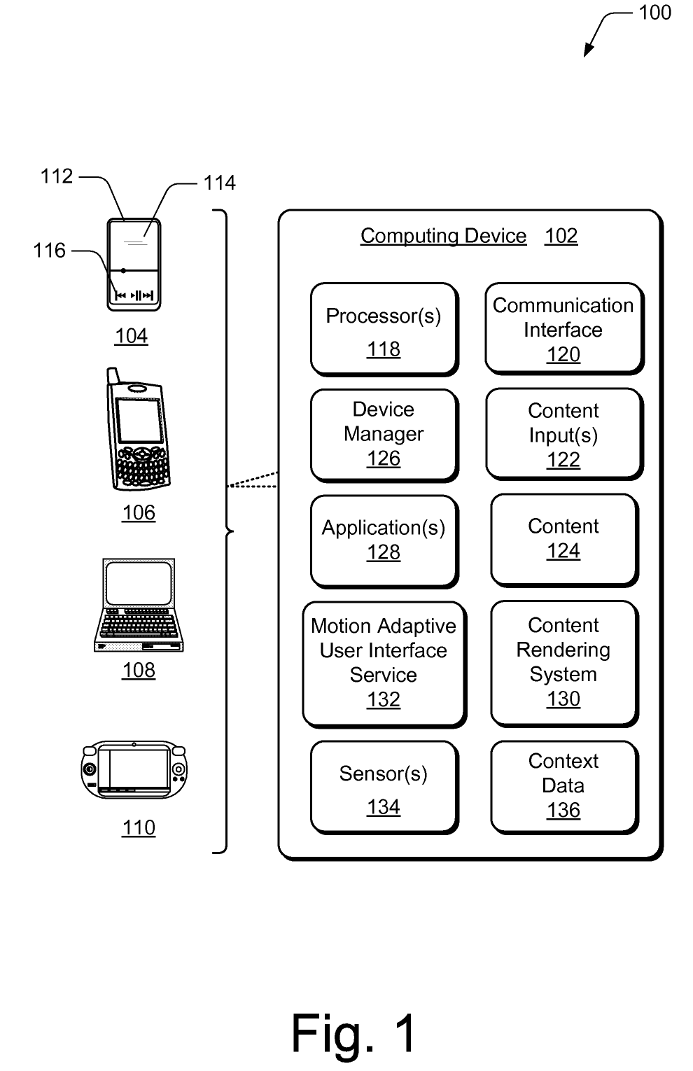

FIG. 1 illustrates an example system in which various embodiments of a motion adaptive user interface service can be implemented. Example system 100 includes computing device 102 (e.g., a wired and/or wireless device) that can be any one or combination of a media device 104 (e.g., a personal media player, portable media player, etc.), a portable communication device 106 (e.g., a mobile phone, PDA, etc.) that is implemented for data, messaging, and/or voice communications, a portable computer device 108, an ultra-mobile personal computer (UMPC) 110, a gaming system, an appliance device, an electronic device, a computer device and/or as any other type of portable device that can receive, display, and/or communicate data in any form of audio, video, and/or image data. Computing device 102 can also be implemented as a navigation and display system in a vehicle or other form of conveyance.

Each of the various portable and/or computing devices can include an integrated display and selectable input controls via which a user can input data. For example, media device 104 includes an integrated display 112 on which a user interface 114 can be displayed. In this example, the user interface 114 is a media player user interface that includes user interface elements 116, such as any type of image, graphic, text, selectable button, user-selectable controls, menu selection, album art, and/or any other type of user interface displayable feature or item.

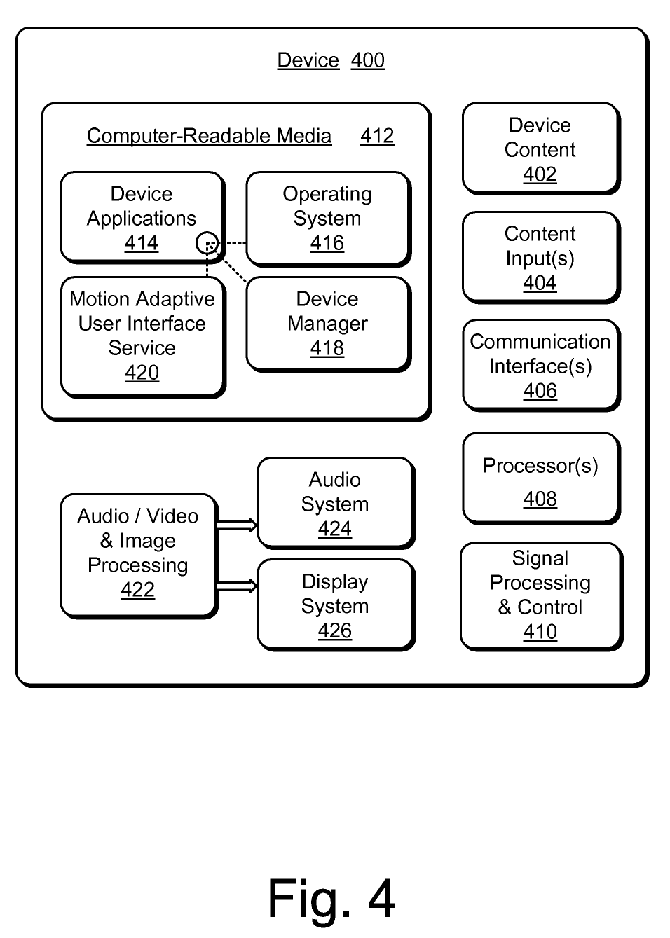

Any of the various portable and/or computing devices described herein can be implemented with one or more processors, communication components, content inputs, memory components, storage media, signal processing and control circuits, and a content rendering system. Any of the portable and/or computing devices can also be implemented for communication via communication network(s) that can include any type of a data network, voice network, broadcast network, an IP-based network, and/or a wireless network that facilitates data, messaging, and/or voice communications. A portable device can also be implemented with any number and combination of differing components as described with reference to the example device shown in FIG. 4. A portable and/or computing device may also be associated with a user (i.e., a person) and/or an entity that operates the device such that a portable device describes logical devices that include users, software, and/or a combination of devices.

In this example, computing device 102 includes one or more processors 118 (e.g., any of microprocessors, controllers, and the like), a communication interface 120 for data, messaging, and/or voice communications, and media content input(s) 122 to receive content 124. Content (e.g., to include recorded content or media content) can include any type of audio, video, and/or image media content received from any content source, such as television media content, music, video clips, data feeds, interactive games, network-based applications, and any other content. Computing device 102 also includes a device manager 126 (e.g., a control application, software application, signal processing and control module, code that is native to a particular device, a hardware abstraction layer for a particular device, etc.).

Computing device 102 can include various applications 128 that that can be processed, or otherwise executed, by the processors 118, such as a media player application that generates the media player user interface as user interface 114 for display on media device 104. Computing device 102 includes a content rendering system 130 that can render user interfaces from the applications 128 to generate a display on any of the portable devices. Computing device 102 also includes a motion adaptive user interface service 132 that can be implemented as computer-executable instructions and executed by the processors 118 to implement various embodiments and/or features of a motion adaptive user interface service. In an embodiment, the motion adaptive user interface service 132 can be implemented as a component or module of the device manager 126.

In this example, computing device 102 includes various context providers that can be implemented to provide context data 136 associated with the computing device. Sensor(s) 134 are a type of context provider that provide context about the physical world. Various sensor(s) can be implemented to sense movement of the device to generate context data 136 associated with the movement. Examples of sensor(s) may include accelerometers, a global positioning system (GPS) unit, light sensors, thermometers, vibration sensors, and/or a webcam from which an image stream can be analyzed to detect and estimate motion. For example, a portable and/or computing device equipped with an accelerometer can be implemented to sense an acceleration of the device, such as when a user that is holding the device is walking or running. Similarly, a portable and/or computing device equipped with a GPS unit can be implemented to sense multiple locations of the device, which can also be used to determine that the device is moving, or being moved.

In various embodiments, the motion adaptive user interface service 132 at computing device 102 can receive context data 136, such as acceleration data or position data, from various context providers, such as sensor(s) 134, and using the context data, determine movement of the device. Examples of movement include, but are not limited to, running, jogging, walking, traveling in a car, and/or on a train. In some instances, the motion adaptive user interface service 132 can be implemented to receive multiple different types of context data from multiple sensors to determine movement of the device. For example, motion adaptive user interface service 132 can be implemented to receive both context data, indicating a specific vibration pattern, and acceleration data to determine that the device is in a car, rather than being held by a user who is walking, based on both the acceleration data and the pattern of vibration. As noted above, context data is not limited to data received from sensors. For example, the motion adaptive user interface service can be implemented to receive data, such as a current time or a current weather temperature, from a network such as the Internet at communication interface 120.

In various embodiments, based on the context data received from various context providers, and after using the context data to determine movement of the device, motion adaptive user interface service 132 can be implemented to initiate an enhancement of the user interface 114 for ease of usability based on the determined movement of the device. An enhancement of the user interface 114 for ease of usability based on the movement of the device can include modifications to the user interface that make the user interface displayed on the device easier to use and operate, such as by improving readability, targetability, and/or accessibility of the user interface based on how the device is being used.

In some embodiments, user interface elements 116, such as user-selectable controls, of a user interface 114 for an application 128 that is displayed on the integrated display 112 can be rearranged, resized (e.g., increased in sized), removed, and/or reshaped for ease of usability. For example, when a user is jogging and holding media device 104, it may be difficult for the user to see and select small user-selectable controls that are displayed on the integrated display 112. Accordingly, motion adaptive user interface service 132 can be implemented to initiate an increase in the size of one or more of the user selectable controls that are displayed on the integrated display 112 so that the user can more easily see and select the control when the user is running. In other embodiments, based on the context data received from various context providers, and after using the context data to determine movement of the device, motion adaptive user interface service 132 can be implemented to initiate removing a user-selectable control from the user interface 114 displayed on the integrated display 112.

In various embodiments, motion adaptive user interface service 132 can be implemented to initiate an enhancement of user interface 114 by communicating an indication of device movement, such as a motion signal, that can be received by any of different applications 128. Different applications can then implement different enhancements of the user interface responsive to the motion signal. For example, the motion adaptive user interface service 132 can detect that a user is holding a computing device while riding in a car, and send an in-car motion signal to the applications 128. The motion signal can then be received by the different applications that modify the user interface accordingly, and respective to each different application. For example, responsive to receiving an in-car motion signal, a media player application can select a different user interface that includes enlarged media playing controls for a media player user interface, whereas a word processing application can select a different user interface to enlarge the font of text displayed in a document on the user interface.

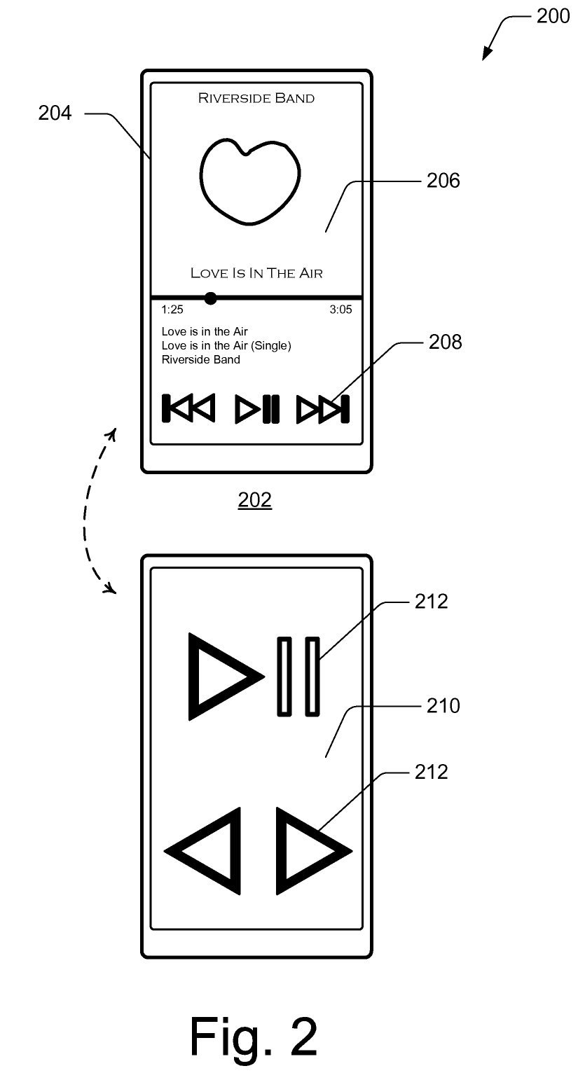

FIG. 2 illustrates an example 200 of motion adaptive user interface service in accordance with one or more embodiments. Example 200 includes a device 202 illustrated as a media device that can be implemented to play audio and/or video media. While not illustrated in FIG. 2, device 202 can include one or more sensors, as well as a motion adaptive user interface service, such as motion adaptive user interface service 132 of computing device 102. Device 202 includes an integrated display 204 on which a user interface 206 can be displayed. In this example, the user interface is a media player user interface that includes user-selectable controls 208, which include a play/pause control, a skip backward control, and a skip forward control. User selectable controls 208 are displayed on the integrated display 204 and are selectable by physically touching the user selectable controls on the integrated display, such as on a touch-screen display. For example, a user can touch the play/pause button on the integrated display to play or pause a song or video that is being rendered on the device. The user interface 206 is an example display of a media player user interface that can be used when the device is not moving.

Example 200 also illustrates device 202 with an enhanced media player user interface 210 that can be displayed on the integrated display when the device is moving, such as when a user is holding the device and jogging. For example, one or more sensors (not shown), such as an accelerometer, can be implemented to sense movement of the device. A motion adaptive user interface service (also not shown) can be implemented to initiate an enhancement to the user interface for ease of usability based on the movement of the device. Alternatively or in addition, the motion adaptive user interface service can detect movement of the device and communicate a motion signal to a media device application that selects to display the enhanced user interface 210. In this example, after sensing movement of the device, the user selectable controls 212 displayed on the enhanced media player user interface 210 have been rearranged, resized, and reshaped for display at device 202. For instance, the play/pause control is moved to the top of user interface 210 and is increased in size. Similarly, the skip backward and skip forward controls are moved and also increased in size. Additionally, the skip backward and skip forward controls are modified into different shapes. Furthermore, selectable controls that are not often used, such as a playback index and other high-level navigation controls, and displayed data that is not often needed, such as data associated with the currently playing song, have been removed from the enhanced user interface 210.

The user selectable controls 212 on device 202 have been rearranged, resized, and reshaped for ease of usability of the device based on movement of the device. For instance, a user that is holding device 202 while jogging or running may have a difficult time selecting the user-selectable controls 208 before the enhancement is initiated. However, when the enhancement is initiated and/or the enhanced user interface 210 is selected for display, the user selectable controls 212 are resized, rearranged, and reshaped to make the user selectable controls on device 202 easier to see and select.

In various embodiments, there can be a transition delay before transitioning from a standard or non-motion user interface to an enhanced user interface when a device is in motion to prevent the transition between the user interfaces during short movements or motions of a device. For example, if a device is picked up off of a table so that a user can take a closer look at the display, it may be both confusing and disorienting to see the display change from a non-motion user interface to an enhanced user interface. Furthermore, the user may prefer to look at the standard user interface because the user is not moving. However, the movement caused by picking the device up off of the table may cause the user interface to transition from the standard user interface to the enhanced user interface. Accordingly, a transition delay can be implemented to delay the transition between user interfaces until the movement of the device is detected as a constant velocity or acceleration, or until the device has been moving for a predetermined amount of time.

In addition to user interface elements and/or user-selectable controls that can be rearranged, resized (e.g., increased in sized), removed, and/or reshaped for ease of usability on a user interface, user interface elements and selectable controls can also be implemented to change size and position approximately instantaneously or with displayed animation. In the course of a few seconds, an element or selectable control can be implemented to fade away leaving an empty space, while some of the remaining elements and/or selectable controls smoothly increase in size and become larger to fill the space, while still other remaining elements and/or selectable controls slide around so that all of the remaining elements and controls are displayed and not covered up. A user interface that includes user interface elements and/or user-selectable controls can appear to be rearranged as a result of motion to improve readability, targetability, and/or accessibility of the user interface elements and controls.

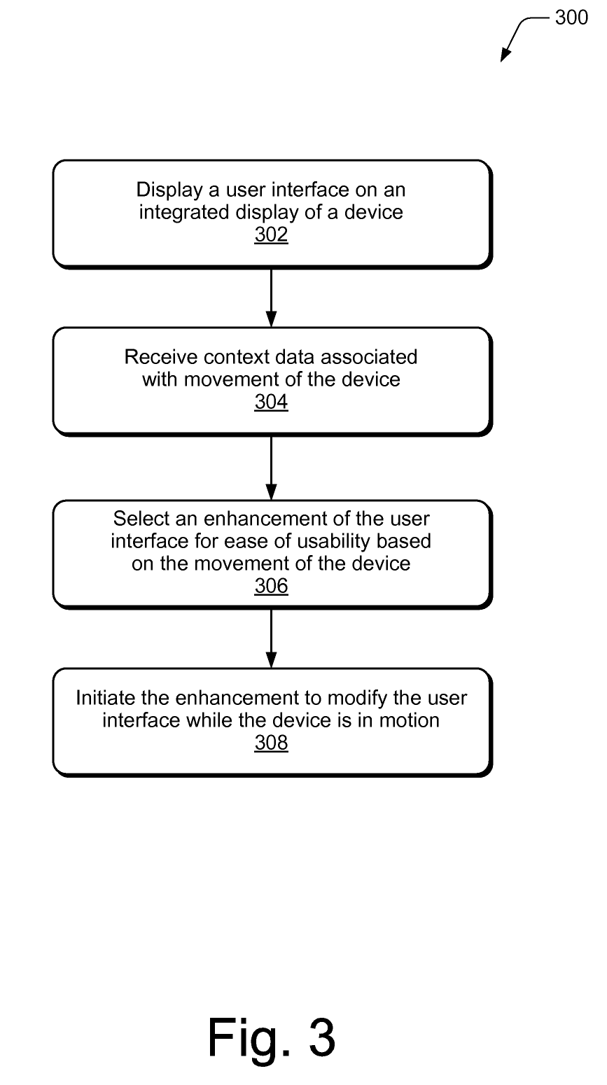

Example method 300 is described with reference to FIG. 3 in accordance with one or more embodiments of motion adaptive user interface service. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example method(s) may be described in the general context of computer-executable instructions, which can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of a motion adaptive user interface service. The order in which the method is described is not intended to be construed as a limitation, and any number of the described method blocks can be combined in any order to implement the method, or an alternate method.

At block 302, a user interface is displayed for viewing on an integrated display of a device. For example, computing device 102 (FIG. 1) includes user interface 114 that is displayed on integrated display 112 when an application 128 executes on the device. At block 304, context data associated with movement of the device is received. In some embodiments, context data can include acceleration data and/or position data. For example, computing device 102 can include multiple sensor(s) 134 that sense movement or motion of the device, and motion adaptive user interface service 132 receives the context data that is associated with the movement.

At block 306, an enhancement of the user interface is selected for ease of usability based on the movement of the device and, at block 308, the enhancement to modify the user interface is initiated while the device is in motion. In some embodiments, one or more user-selectable controls of the application that are displayed on the user interface are rearranged, resized, reshaped, and/or removed for ease of usability. For example, user-selectable controls 208 (FIG. 2) are rearranged, resized, and reshaped to make the user selectable controls easier to see and select. In addition, one or more of the user-selectable controls can be removed from the user interface.

FIG. 4 illustrates various components of an example device 400 that can be implemented as any form of a portable media device 104 (e.g., a personal media player, portable media player, etc.), a portable communication device 106 (e.g., a mobile phone, PDA, etc.), a portable computer device 108, an ultra-mobile personal computer (UMPC) 110, a gaming system, an appliance device, an electronic device, and/or as any other type of portable and/or computing device to implement various embodiments of a motion adaptive user interface service. For example, device 400 can be implemented as a computing device, portable media device, portable communication device, portable computer device, or an ultra-mobile personal computer as described with reference to FIG. 1 and/or FIG. 2.

Device 400 can include device content 402, such as configuration settings of the device, media content stored on the device, and/or information associated with a user of the device. Media content stored on device 400 can include any type of data as well as audio, video, and/or image media content. Device 400 can include one or more content inputs 404 via which content can be received. In an embodiment, the content inputs 404 can include Internet Protocol (IP) inputs over which streams of media content are received via an IP-based network.

Device 400 further includes one or more communication interfaces 406 that can be implemented as any one or more of a serial and/or parallel interface, a wireless interface, any type of network interface, a modem, and as any other type of communication interface. The communication interfaces 406 provide a connection and/or communication links between device 400 and a communication network by which other electronic, computing, and communication devices can communicate data with device 400.

Device 400 can include one or more processors 408 (e.g., any of microprocessors, controllers, and the like) which process various computer-executable instructions to control the operation of device 400 and to implement embodiments of motion adaptive user interface service. Alternatively or in addition, device 400 can be implemented with any one or combination of hardware, firmware, or fixed logic circuitry that is implemented in connection with signal processing and control circuits which are generally identified at 410.

Device 400 can also include computer-readable media 412, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 412 provides data storage mechanisms to store the device content 402, as well as various device applications 414 and any other types of information and/or data related to operational aspects of device 400. For example, an operating system 416 can be maintained as a computer application with the computer-readable media 412 and executed on the processors 408. The device applications 414 can also include a device manager 418 and a motion adaptive user interface service 420. In this example, the device applications 414 are shown as software modules and/or computer applications that can implement various embodiments of motion adaptive user interface service.

Device 400 can also include an audio, video, and/or image processing system 422 that provides audio data to an audio system 424 and/or provides video or image data to a display system 426. The audio system 424 and/or the display system 426 can include any devices or components that process, display, and/or otherwise render audio, video, and image data. The audio system 424 and/or the display system 426 can be implemented as integrated components of the example device 400. Alternatively, audio system 424 and/or the display system 426 can be implemented as external components to device 400. Video signals and audio signals can be communicated from device 400 to an audio device and/or to a display device via an RF (radio frequency) link, S-video link, composite video link, component video link, DVI (digital video interface), analog audio connection, or other similar communication link.

Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of motion adaptive user interface service have been described in language specific to features and/or methods, it is to be understood that the subject of the appended claims is not necessarily limited to the specific features or methods described. Rather, the specific features and methods are disclosed as example implementations of motion adaptive user interface service.

1. A method, comprising:
displaying a user interface on an integrated display of a device when an application is executed on the device;
receiving context data associated with movement of the device;
selecting an enhancement of the user interface for ease of usability based on the movement of the device; and
initiating the enhancement to modify the user interface while the device is in motion.

2. A method as recited in claim 1, wherein one or more user-selectable controls of the application that are displayed on the user interface are rearranged for ease of usability.

3. A method as recited in claim 1, wherein one or more user-selectable controls of the application that are displayed on the user interface are resized for ease of usability.

4. A method as recited in claim 1, wherein the enhancement to modify the user interface while the device is in motion is initiated after a transition delay.

5. A method as recited in claim 1, wherein the user interface includes multiple user-selectable controls of the application, and wherein at least one of the user-selectable controls is increased in size for ease of usability, and at least one of the user-selectable controls is removed from the user interface.

6. A method as recited in claim 1, wherein the context data includes acceleration data that indicates a type of the movement of the device.

7. A method as recited in claim 1, wherein the context data includes positioning data that indicates the movement of the device.

8. A method as recited in claim 1, wherein the context data is received from one or more sensors integrated with the device.

9. A device, comprising:
an integrated display configured to display a user interface of an application when executed on the device;
one or more sensors configured to sense movement of the device; and
a motion adaptive user interface service configured to initiate an enhancement of the user interface for ease of usability based on the movement of the device.

10. A device as recited in claim 9, wherein one or more user-selectable controls of the application that are displayed on the user interface are rearranged for ease of usability.

11. A device as recited in claim 9, wherein one or more user-selectable controls of the application that are displayed on the user interface are resized for ease of usability.

12. A device as recited in claim 9, wherein the user interface includes multiple user-selectable controls of the application, and wherein at least one of the user-selectable controls is increased in size for ease of usability, and at least one of the user-selectable controls is removed from the user interface.

13. A device as recited in claim 9, wherein the motion adaptive user interface service is further configured to receive context data that is associated with the movement of the device, the context data including acceleration data that indicates a type of the movement of the device.

14. A device as recited in claim 9, wherein the motion adaptive user interface service is further configured to receive context data that is associated with the movement of the device, the context data including positioning data that indicates the movement of the device.

15. A device as recited in claim 9, wherein the device comprises a portable device.

16. One or more computer-readable media comprising computer-executable instructions that, when executed, initiate a motion adaptive user interface service to:
receive context data associated with movement of a device;
select an enhancement of a user interface for ease of usability based on the movement of the device, the user interface being displayed on an integrated display when an application is executed on the device; and
initiate the enhancement to modify the user interface while the device is in motion.

17. One or more computer-readable media as recited in claim 16, further comprising computer-executable instructions that, when executed, direct the motion adaptive user interface service to rearrange one or more user-selectable controls for ease of usability when displayed on the user interface.

18. One or more computer-readable media as recited in claim 16, further comprising computer-executable instructions that, when executed, direct the motion adaptive user interface service to resize one or more user-selectable controls for ease of usability when displayed on the user interface.

19. One or more computer-readable media as recited in claim 16, further comprising computer-executable instructions that, when executed, direct the motion adaptive user interface service to receive the context data as acceleration data.

20. One or more computer-readable media as recited in claim 16, further comprising computer-executable instructions that, when executed, direct the motion adaptive user interface service to receive the context data as positioning data.
